(19) United States
(12) Patent Application Publication
(10) Pub. No.: US 2008/0081137 A1
(43) Pub. Date: Apr. 3, 2008

(54) POLYMER BLEND COMPOSITION AND ARTICLES THEREOF

(75) Inventors: John Chi Hee Kwok, Moon Township, PA (US); Robert D. Roberts, Millers Falls, MA (US)

Correspondence Address: NOVA Chemicals Inc., Westpointe Center, 1550 Coraopolis Heights Road, Moon Township, PA, 15108, US

(73) Assignee: NOVA Chemicals Inc., Moon Township, PA (US)

(21) Appl. No.: 11/856,103

(22) Filed: Sep. 17, 2007

Related U.S. Application Data
(60) Provisional application No. 60/848,452, filed on Sep. 29, 2006.

(51) Int. Cl. C08L 33/02; B29D 22/00

(52) U.S. Cl. 428/35.7; 525/209; 525/221

(57) ABSTRACT

A polymer blend composition having improved physical properties comprises (i) 70% to 95% by weight of a blend of a styrene maleic anhydride (SMA) copolymer, e.g., rubber modified styrene maleic anhydride copolymer and a styrene polymer e.g., polystyrene or high impact polystyrene (HIPS) and (ii) from 30% to 5% by weight of an acrylic copolymer, e.g., a rubber modified styrene methyl methacrylate (SMMA) copolymer which acts as a compatibilizer for the SMA copolymer, which may be a regrind, and the styrene polymer. This polymer blend composition has good impact strength and elongation properties. The weight percent ratio of the SMA copolymer to styrene polymer in component (i) may be 95:5 or 5:95 based on the total weight of component (i). The polymer blend composition may be extruded into sheet and thermoformed into an article, e.g., a container for packaged foods or may be co-extruded to produce a laminated article.

This application claims the benefit of priority of U.S. Provisional Application Ser. No. 60/848,452, filed Sep. 29, 2006, entitled “Polymer Blend Composition And Articles Thereof”, which is herein incorporated by reference in its entirety.

### BACKGROUND OF THE INVENTION

1. Field of the invention

The present invention relates to a polymer blend composition comprising a first component (i) comprised of a blend of a styrene maleic anhydride copolymer (SMA) composition, e.g., rubber modified styrene maleic anhydride copolymer and a styrene polymer, e.g., polystyrene or rubber modified polystyrenes (high impact polystyrene); and (ii) an acrylic copolymer composition, e.g., styrene methyl methacrylate copolymer (SMMA) or a rubber modified styrene methyl methacrylate copolymer (SMMA) composition that acts as a compatibilizer for the two chemicals of component (i). More particularly, the present invention relates to combining an SMA composition with a styrene polymer and the use of an acrylic copolymer for compatibilizing the SMA composition. The SMA composition may be a regrind whereby the costs of the polymer system can be reduced. The polymer blend composition of the invention has good impact resistance and elongation properties.

2. Background Art

It is known to copolymerize styrene and maleic anhydride to produce SMA. Such processes have been described at length in the literature, especially in Baer U.S. Pat. No. 2,971,939 and Hanson U.S. Pat. No. 2,769,804, and beneficially as a solution as disclosed in Zimmerman U.S. Pat. No. 3,336,267.

It is known in the art to modify styrene maleic anhydride copolymers with rubber. Generally, these copolymers are referred to as “rubber modified styrene/maleic anhydride copolymers”. It is known that the rubber component provides increased impact resistance and that the maleic anhydride component provides a high heat distortion temperature. An improved method for preparing a styrene/maleic anhydride/diene rubber composition suitable for extrusion and molding and having a high heat distortion temperature and desired impact resistance is disclosed in Moore et al. U.S. Pat. No. 3,191,354 (The Dow Chemical Company), which was issued on Nov. 11, 1975.

Hathaway et al. U.S. Pat. No. 5,219,628 (The Dow Chemical Company), which was issued on Jun. 15, 1993, discloses a multi-layer container for use in microwave cooking of food. The container comprises a substrate layer of thermoplastic polymer that is not suitable for contact with the food, and an inner layer comprised of a blend of styrene/maleic anhydride copolymer and a polymer selected from the group consisting of polystyrene, rubber modified polystyrene, polymethyl methacrylate, rubber modified polymethyl methacrylate, polypropylene, and mixtures thereof. This patent also teaches that rubber modified styrene/maleic anhydride copolymers may also be used, but are not preferred.

It is known to produce various shaped articles from foamed and unfoamed thermoplastic materials such as polystyrene sheet or impact modified polystyrene sheet (i.e., high impact polystyrene sheet) by thermoforming methods. Many such articles are containers used for packaged foods.

Chundury et al. U.S. Pat. No. 5,106,696 (assigned to Ferro Corporation), which was issued on Apr. 21, 1992 discloses and claims a thermoformable multi-layer structure for packaging materials and foods. A polymer composition for a first layer of the structure comprises: (A) 49% to 90% by weight of a polyolefin, i.e., polypropylene, polybutene; (B) 10% to 30% by weight of a copolymer of styrene and maleic anhydride; (C) 2% to 20% by weight of a compatilizing agent, i.e., a starblock, diblock or mixtures thereof of a copolymer of styrene and butadiene; (D) 0 to 5% by weight of a triblock copolymer of styrene and butadiene; and (E) 20% by weight of talc. The second layer of the structure is made of polypropylene.

A number of process designs are disclosed in the patent literature involving polymerization techniques, reactor configurations and mixing schemes that are used to incorporate maleic anhydride in a styrene/maleic anhydride copolymer. Examples include Tanaka et al. U.S. Pat. No. 4,328,327 assigned to Daicel Chemical Industries, Ltd., Meyer et al. U.S. Pat. No. 4,921,906 assigned to Stamicarbon B. V., and the above Moore et al. U.S. Pat. No. 3,919,354 assigned to The Dow Chemical Company.

The latter document, i.e., U.S. Pat. No. 3,919,354, discloses an improved styrene/maleic anhydride/diene rubber composition suitable for extrusion and molding and having a high heat distortion temperature and desired impact resistance. The process for the preparation of the polymer involves modifying a styrene-maleic anhydride copolymer with diene rubber by polymerizing the styrene monomer and the anhydride in the presence of the rubber. More particularly, the process involves providing a styrene having rubber dissolved therein; agitating the styrene/rubber mixture and initiating free radical polymerization thereof; adding to the agitated mixture the maleic anhydride at a rate substantially less than the rate of polymerization of the styrene monomer; and polymerizing the styrene monomer and the maleic anhydride. The polymer contains rubber particles ranging from 0.02 to 30 microns dispersed throughout a matrix of polymer of the styrene monomer and the anhydride with at least a major portion of the rubber particles containing occlusions of the polymerized styrene monomer and maleic anhydride.

This patent teaches that the polymers are suited for extrusion into sheet or film, which are then employed for thermoforming into containers, packages and the like. Alternately, the polymers can be injection molded into a wide variety of components such as dinnerware and heatable frozen food containers.

However, polymers as those disclosed in the above U.S. Pat. No. 3,919,354 are generally brittle, and, therefore, capable of breaking even though these polymers have the thermal properties to withstand temperatures above 210° F., generally used in heating food in a microwave oven.

U.S. Published Application No. 2005-0020756 A1 published on Jan. 27, 2005, discloses a styrenic resin composition comprising a rubber modified styrene/maleic anhydride copolymer and polybutene, which in effect, enhances the rubber modified styrene/maleic anhydride copolymer, and which styrenic resin composition can be used to produce a container suitable for packaged foods that could withstand the temperatures needed for heating foods in a microwave oven without the container breaking, especially upon removal of the container from the microwave oven.

Rubber modified styrene methyl methacrylate copolymers are known. U.S. Pat. No. 4,772,667 to Biletch et al. discloses a thermoplastic polymer that includes a styrenic monomer, an acrylate, a methacrylate and a block copolymer.

U.S. Pat. No. 5,290,862 to Blasius discloses a polymer alloy that contains from 30 to 83 weight percent of a brittle polymer; from 3 to 50 weight percent of a rubbery polymer; and from 15 to 67 weight percent of a ductile polymer, provided that the ductile polymer and the rubbery polymer are at least compatible.

U.S. Pat. No. 5,891,962 to Otsuzuki et al. discloses a transparent, rubber-modified styrene resin that contains 70 to 96 parts by weight of a copolymer formed of 20 to 70 wt. % of styrene monomer units and 30 to 80 wt. % of alkyl (meth)acrylate monomer units and 4 to 30 parts by weight of a rubbery polymer. The rubbery polymer is dispersed in the copolymer as particles and the copolymer and the rubbery polymer have substantially the same refractive index.

It is known to regrind polymer materials and to recycle this regrind in future applications. Examples of regrind and its application appear in U.S. Pat. Nos. 5,064,724; 7,048,176; and 7,056,573. U.S. Pat. No. 5,064,724 discloses that since some of the materials are very expensive and the scrap material or regrind can only be sold for a fraction of the cost of the original materials, as much of the regrind as possible is reused in order to make the cost of the plastic containers competitive with glass and metal containers.

It is known that a styrene/maleic anhydride copolymer composition may be relatively expensive and therefore, it may be desirable to re-use the regrind for cost savings purposes. In order to optimize this cost savings, it would be ideal if this SMA regrind could be combined with a virgin SMA copolymer or with an inexpensive resin, for example, a styrene polymer, e.g., polystyrene or high impact polystyrene. Alternatively, the SMA copolymer could be added to an inexpensive resin, for example, polystyrene or high impact polystyrene to improve its performance at a modest cost. However, it is known that blends of styrene/maleic anhydride copolymers and polystyrene or high impact polystyrene (HIPS) are not compatible in that the addition of polystyrene or HIPS to an SMA copolymer generally leads to a reduction in mechanical properties, e.g., toughness and elongation properties, of such blends.

### SUMMARY OF THE INVENTION

It has been found by the inventors that a polymer blend composition comprising a styrene/maleic anhydride (SMA) copolymer composition, e.g., rubber modified styrene/maleic anhydride copolymer and a styrene polymer, e.g., polystyrene or rubber modified polystyrene (HIPS) can be blended together and compatibilized through the use of an acrylic copolymer, e.g., rubber modified styrene methyl methacylate (SMMA) copolymer for enhancing at least the mechanical properties of the polymer blend composition. This becomes important when using a styrene/maleic anhydride copolymer or a styrene/maleic anhydride copolymer regrind in blends with a styrene polymer, e.g., polystyrene or high impact polystyrene (HIPS). When the acrylic copolymer, e.g., rubber modified styrene methyl methacrylate (SMMA) copolymer, is added to the SMA copolymer and the styrene polymer, a polymer blend composition is produced with good physical properties.

The polymer blend composition can be used to produce sheets, which, in turn, may be used to produce articles, e.g., food containers for use in heating foods in microwave ovens, and which containers may be formed via thermoforming techniques. The physical properties of the resultant polymer blend composition and therefore, the articles produced from this composition include excellent toughness and elongation properties.

The polymer blend composition having improved physical characteristics, comprises:

(i) from about 70% to about 95% by weight of a blend of a styrene/maleic anhydride copolymer composition, e.g., rubber modified SMA copolymer and a styrene polymer, e.g., polystyrene or high impact polystyrene; and

(ii) from about 30% to about 5% by weight of an acrylic copolymer, e.g., rubber modified styrene methyl methacrylate copolymer composition, said component (ii) acting as a compatibilizer for the styrene maleic anhydride copolymer composition and said styrene polymer of component (i).

In an embodiment, component (i) comprises from about 95% to about 5% by weight styrene/maleic anhydride copolymer composition and from about 5% to about 95% by weight styrene polymer based on the weight of component (i). In another embodiment, component (i) comprises about 50% by weight styrene/maleic anhydride copolymer composition and about 50% by weight styrene polymer based on the weight of component (i).

The invention also provides for extruded thermoplastic sheets made from the polymer blend composition of the invention, as well as thermoformed articles made from the sheet. An example of an article is a container for packaged foods that is to be heated in a microwave oven and which article has improved toughness, elongation, and heat distortion resistance properties.

Furthermore, there is provided a multi-layer thermoplastic composite comprising a substrate layer and a layer made from the polymer blend composition of the invention, which multi-layer composite can be thermoformed into articles, e.g., containers suitable for heating purposes in microwave ovens, and which articles have improved toughness, elongation, and heat distortion resistance properties.

These and other objects of the present invention will be better appreciated and understood by those skilled in the art from the following description and appended claims.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that may vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers, graft copolymers, and terpolymers.

Unless otherwise specified, all molecular weight values are determined using gel permeation chromatography (GPC) using appropriate polystyrene standards. Unless otherwise indicated, the molecular weight values indicated herein are weight average molecular weights (Mw).

The polymer blend composition of the invention is comprised of a styrene maleic anhydride (SMA) copolymer composition. In one embodiment of the invention, this styrenic resin composition may be that fully disclosed in the above-discussed patent application bearing U.S. Published Application No. 2005-0020756 A1, published on Jan. 27, 2005, the teachings of which are incorporated herein by reference in their entirety. More particularly, the styrenic resin composition may preferably be a rubber modified styrene maleic anhydride copolymer composition comprised of rubber, styrene, maleic anhydride, and optionally, polybutene. If present, and as taught in U.S. Published Application No. 1005-0020756 A1, the weight amount of the polybutene will range from about 2% to 6% by weight, more preferably 3% to 5% by weight based on the modified styrene maleic anhydride copolymer composition, and the polybutene will have a number average molecular weight ranging from about 900 to about 2500, preferably, from about 900 to 1300.

As also taught in U.S. Published Application No. 2005-0020756 A1, the rubber modified styrene maleic anhydride copolymer composition is comprised of from about 92.0% to about 99.9% by weight rubber modified styrene maleic anhydride copolymer, and from about 0.1% to about 8.0% by weight of polybutene based on the weight of the rubber modified styrene maleic anhydride copolymer composition. The rubber modified styrene maleic anhydride copolymer is comprised of from about 2% to about 25% by weight of maleic anhydride and from about 4% to about 20% by weight of rubber based on the weight of the rubber modified styrene maleic anhydride copolymer. In a preferred embodiment, the amount of rubber ranges from about 8% to about 15% by weight. The particle size of the rubber ranges from about 0.1 micron to about 11 microns, preferably, less than 6 microns, and more preferably, ranges from about 0.1 micron to about 5 microns. The rubber is either high cis polybutadiene or medium cis polybutadiene.

In addition to the SMA copolymer composition, the polymer blend composition of the invention is comprised of a styrene polymer, preferably, polystyrene or high impact polystyrene, and an acrylic copolymer, preferably, rubber modified styrene methyl methacrylate copolymer composition, which acts as a compatibilizer for the rubber modified styrene maleic anhydride copolymer composition and the styrene polymer.

In the present invention, the polymer blend composition has improved physical characteristics, and comprises:

(i) from about 70% to about 95% by weight of a blend of a styrene/maleic anhydride copolymer composition, e.g., rubber modified SMA copolymer and a styrene polymer, e.g., polystyrene or high impact polystyrene; and

(ii) from about 30% to about 5% by weight of an acrylic copolymer, e.g., rubber modified styrene methyl methacrylate copolymer composition, said component (ii) acting as a compatibilizer for the styrene maleic anhydride copolymer composition and said styrene polymer of component (i).

In an embodiment of the invention, component (i) comprises from about 95% to about 5% by weight styrene/maleic anhydride copolymer composition and from about 5% to about 95% by weight styrene polymer based on the weight of component (i). In a further embodiment of the invention, component (i) comprises about 50% by weight styrene/maleic anhydride copolymer composition and about 50% by weight styrene polymer based on the weight of component (i).

The polymer blend composition of the invention is comprised of a styrene maleic anhydride (SMA) copolymer composition. Suitable SMA copolymers are those available commercially, and include styrene maleic anhydride copolymers (SMA) available from NOVA Chemicals Inc. under the general trade designation DYLARK. Examples include DYLARK® DBK-290 that generally comprises about 18% by weight of maleic anhydride and about 82% by weight of styrene; DYLARK 332 generally comprising 14% by weight of maleic anhydride and 86% by weight of styrene; and DYLARK 134 generally comprising about 17% by weight of maleic anhydride and 83% by weight of styrene.

Rubber modified styrene maleic anhydride (SMA) copolymer compositions may be used in the polymer blend composition of the invention. A preferred rubber modified styrene maleic anhydride copolymer composition is the styrenic resin composition described in the preceding section and disclosed and claimed in the related parent case U.S. Published Application No. 2005-0020756 A1, published on Jan. 27, 2005. Other impact grades of commercially available rubber modified styrene maleic anhydride copolymers include DYLARK 150, 250, 350 and 700, which are blends and/or grafts of SMA with styrene block rubbers (SBR).

Rubber modified SMA polymers are generally prepared by polymerizing monomers, e.g., styrene and maleic anhydride in the presence of the rubber in such a way that the polymerizing monomers are grafted onto the rubber substrate and a matrix copolymer of essentially the same composition as the graft copolymer is simultaneously generated. Suitable methods of producing such rubber-modified copolymers are well known in the art and a typical process is described in U.S. Pat. No. 3,919,354.

A rubber modified SMA polymer may contain from 5 to 35% by weight of a rubber component and preferably from 10 to 25 percent by weight of such a rubber component. The rubber component may conventionally be a diene rubber such as polybutadiene, polymers of butadiene with a comonomer such as styrene or acrylonitrile, which contain at least 60% and preferably 80% by weight of butadiene or a butadiene based block or radial-block rubber. Other rubbers such as EPDM rubber, polypentenamer, polyisoprene, polychloroprene, polyacrylate rubbers and the like can also be used. These rubber modified SMA copolymers are described in U.S. Pat. No. 4,500,679 assigned to Monsanto Company.

The styrene polymer that may be used in the polymer blend composition of the invention include, for example, polystyrene, high impact polystyrene, medium impact polystyrene, styrene/acrylonitrile copolymers, styrene/acrylonitrile/butadiene (ABS) polymers, syndiotactic polystyrene and styrene/olefin copolymers. Representative styrene/olefin copolymers are substantially random ethylene/styrene or propylene/-styrene copolymers, preferably containing at least 20 weight percent of copolymerized styrene monomer. The amount of styrene polymer employed varies from about 5 to about 100 parts by weight per hundred parts by weight rubber, or block copolymer, preferably about 20 to about 50 parts by weight. The polystyrene may be crystal polystyrene or anionic polystyrene. The anionic polystyrene may have a molecular weight of about 5,000 to about 100,000, or may be lower or higher than this range. The anionic polystyrene may have a molecular weight of 7,000. As for the crystal polystyrene, it is preferred that it have a melt flow greater than 8 and about 15, preferably, the crystal polystyrene has a melt flow of about 15 gm/10 min at 200° C. under 5 kg load.

In an embodiment of the invention, the styrene polymer may be selected from the group consisting of crystal polystyrene, polystyrene, high impact polystyrene, and medium impact polystyrene, available from many manufacturers such as NOVA Chemicals Inc.

An example of an acrylic copolymer that may be used in the invention is a rubber modified styrene methyl methacrylate copolymer, such as those commercially available under the ZYLAR® trade name, for example ZYLAR® 220, 530, and 631 resins. These materials are also available from NOVA Chemicals Inc., where the rubber may be a styrene butadiene block copolymer or a combination of two or more styrene butadiene block copolymers. Additionally, the rubber modified styrene methyl methacrylate (SMMA) copolymers disclosed and claimed in U.S. Pat. No. 5,290,862 issued Mar. 1, 1994 and U.S. Pat. No. 6,734,247 B2 issued May 11, 2004 may be used as component (ii) in the polymer blend composition of the invention. Both of these rubber modified SMMA copolymers contain a styrene methyl methacrylate copolymer and at least two styrene butadiene copolymers.

In an embodiment of the invention, the rubber modified SMMA copolymer of component (ii) of the polymer blend composition may be that disclosed in U.S. Published Application No. 2006-0155063 A1, published on Jul. 13, 2006, pertaining to rubber modified styrenic copolymers, the teachings of which are incorporated herein in their entirety. The rubber modified SMMA copolymer is described as comprising a continuous phase and a dispersed phase, wherein A) the continuous phase comprises a polymer composition resulting from the polymerization of a monomer mixture comprising (i) from about 25 to 75 parts by weight of a styrenic monomer and (ii) from about 25 to 75 parts by weight of an alkyl (meth)acrylate monomer, wherein the alkyl group is a C₁ to C₁₂ linear, branched or cyclic alkyl group, in the presence of the dispersed phase; and B) the dispersed phase comprises from about 2 to about 50 parts by weight of one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene, for a total of 100 parts by weight of the combination of A) and B).

In addition to the above components, the polymer blend composition of the invention can advantageously contain other additives such as plasticizers, antioxidants, stabilizers, flame-retardants, fibers, mineral fibers, dyes, pigments and the like.

In the polymer blend composition of the invention, component (i) which is a blend of styrene maleic anhydride copolymer compositions or the rubber modified styrene maleic anhydride copolymer composition and the styrene polymer may be present at a level of at least 70%, in some cases at least 75% and in other cases at least 80% and can be present at up to 85%, in some cases up to 90%, in other cases up to 95%, by weight based on the polymer blend composition. The component (i) can be present in the polymer blend composition at any level or can range between any of the values recited above.

The styrene polymer of component (i) may be present at a level ranging from about 0.1% to about 99.9% by weight based on the weight of component (i) and the styrene maleic anhydride copolymer composition or the rubber modified styrene maleic anhydride copolymer may be present at a level ranging from about 99.9% to about 0.1% by weight based on the weight of component (i) in the polymer blend composition. In a preferred embodiment, the styrene polymer may be present at a level of at least 50%, in some cases at least 60% and in other cases at least 70%, in some cases at least 80%, in other cases at least 85%, and in some cases at least 90% and in some situations as high as 95% by weight based on the weight of component (i), and the styrene maleic anhydride copolymer composition or the rubber modified styrene maleic anhydride copolymer may be present at a level of at least 50%, in some cases 40%, in other cases 30%, in some cases 20%, and in some situations 15%, in some cases 10%, and still in other cases as low as 5% by weight based on the weight of component (i).

In the polymer blend composition of the invention, component (ii) comprising the acrylic copolymer or rubber modified acrylic copolymer may be present at a level of at least 30%, in some cases at least 25% and in other cases at least 20% and can be present at 15%, in some cases 10%, and in other cases 5%, by weight based on the weight of the polymer blend composition. The component (ii) can be present in the polymer blend composition at any level or can range between any of the values recited above.

The components (i) and (ii) of the polymer blend may be physically mixed or blended together and compounded in a single or twin screw extruding technique, which is well is known to those skilled in the art. As discussed hereinabove, the styrene maleic anhydride copolymer composition or the rubber modified SMA copolymer may be a regrind that is mixed or blended together with the styrene polymer and the acrylic copolymer or rubber modified acrylic copolymer via techniques well known to those skilled in the art.

The invention also provides for extruded thermoplastic sheets made from the polymer blend composition of the invention, as well as thermoformed articles made from the sheet. An example of an article is a container for packaged foods that is to be heated in a microwave oven and which article has improved toughness, elongation, and heat distortion resistance properties. The techniques and equipment used in thermoforming sheets and/or films into containers are well known to those skilled in the art. As described above, the present invention provides articles that are formed by thermoforming any of the above-described foamed sheets to form articles. Because of the properties of the foamed sheets, the articles can include containers suitable for use in microwave heating of food.

As discussed herein above, the styrenic resin composition, which is comprised of a rubber modified styrene maleic anhydride copolymer is suitable for extruding into sheet or film. Such sheet is beneficially employed for thermoforming into food containers especially heatable in microwave ovens. This type of production method can easily result in scrap levels of more than 50%. Since this SMA copolymer material is generally relatively expensive and the scrap material, or regrind, can only be sold for a fraction of the cost of the original materials, as much of the regrind as possible is reused in the polymer blend composition of the invention. The use of this regrind in extruded sheet or film, which in turn, is thermoformed to produce containers for packaging food makes such containers more cost effective.

The polymer blend composition of invention has an IZOD impact ranging from about 3 to about 5 ft-pound-inch, a strain at break ranging from about 30% to about 50%, a flexural modulus ranging from about 300 ksi to about 350 ksi, and a total energy ranging from about 10 foot pound to about 15 foot pound.

The present invention will further be described by reference to the following examples. The following examples are merely illustrative of the invention and are not intended to be limiting. Unless otherwise indicated, all percentages are by weight.

### EXAMPLES

In the Examples, a polymer blend composition of the invention was formed. The polymer blend composition of the invention was comprised of a rubber modified styrene maleic anhydride composition, a crystal polystyrene, and a rubber modified SMMA copolymer that was dry blended together in a Banbury mixer. The formed resins were injection molded into test specimens and tested by the following methods. The elongation at break was measured by ASTM-D638; the IZOD notched impact by ASTM-D256; the VICAT heat distortion temperature by ASTM-D1525; the Deflection Temperature Under Load (DTUL) by ASTM-D648 on specimens annealed at 70° C. with 264 psi flexural stress; the Instrumented Impact by ASTM D-3763 with a 38 mm diameter hole clamp. The results are tabulated in the Table 1 below.

### Examples 1-4 and Comparative Examples E, F, and G

Comparative Example E (Comp E) was a 100% rubber modified SMA (DYLARK FG 2500 grade produced and sold by NOVA Chemicals Inc.).

Comparative Example F (Comp F) was a high impact polystyrene (HIPS) product produced and sold by NOVA Chemicals Inc.).

Comparative Example G (Comp G) was a 50% rubber modified SMA (the product of Comparative Example E) and 50% HIPS (the product of Comparative Example F).

Example 1 (Ex 1) was a polymer blend composition of the invention containing the 50/50 blend of Comparative Example G and 5% by weight rubber modified SMMA (ZYLAR 560 grade produced and sold by NOVA Chemicals Inc.).

Example 2 (Ex 2) was a polymer blend composition of the invention containing the 50/50 blend of Comparative Example G and 10% by weight of a rubber modified SMMA used in Example 1.

Example 3 (Ex 3) was a polymer blend composition of the invention containing the 50/50 blend of Comparative Example G and 20% by weight of a rubber modified SMMA used in Example 1.

Example 4 (Ex 4) was a polymer blend composition of the invention containing the 50/50 blend of Comparative Example G and 30% by weight of a rubber modified SMMA used in Example 1.

The several materials of these Examples were blended together in a Banbury mixer and were injection molded into test specimens.

TABLE 1

| | | | | Ex 1 | Ex 2 | Ex 3 | Ex 4 |
|---|---|---|---|---|---|---|---|
| | Comp E | Comp F | Comp G | 5% SMMA | 10% SMMA | 20% SMMA | 30% SMMA |
| IZOD (ft.lbs./in.) | 4.63 | 5.64 | 2.85 | 3.71 | 4.20 | 4.69 | 5.02 |
| Strain @ Break (%) | 13.96 | 55.52 | 29.85 | 36.67 | 51.89 | 62.48 | 59.77 |
| Flex Modulus (ksi) | 301.47 | 357.94 | 323.92 | 324.46 | 326.53 | 331.33 | 335.23 |
| Instrumented Impact | | | | | | | |
| Total Energy(ft-lb) | 11.70 | 14.88 | 10.09 | 10.86 | 11.32 | 12.06 | 13.46 |

As can be seen, without the SMMA component, the blend (Comp G) of SMA (Comp E) and HIPS (Comp F) has less toughness than either of these components alone, as indicated by a drop in IZOD, strain at break and Instrumented Impact properties. The addition of the 5%, 10%, 20%, and 30% by weight rubber modified SMMA to the 50/50 percent by weight blend (Comp G) of rubber modified SMA material and the polystyrene material (Comp F) resulted in increasing toughness in a linear relationship.

While the present invention has been particularly set forth in terms of specific embodiments thereof, it will be understood in view of the instant disclosure that numerous variations upon the invention are now enabled yet reside within the scope of the invention. Accordingly, the invention is to be broadly construed and limited only by the scope and spirit of the claims now appended hereto.

What is claimed is:

1. A polymer blend composition having improved physical characteristics, comprising:
(i) from about 70% to about 95% by weight of a blend of a styrene maleic anhydride copolymer composition and a styrene polymer; and
(ii) from about 30% to about 5% by weight of an acrylic copolymer, said component (ii) acting as a compatibilizer for the styrene maleic anhydride copolymer composition and said styrene polymer of component (i).

2. A polymer blend composition of claim 1 wherein said component (i) comprises:
about 5% to about 95% by weight of said styrene maleic anhydride copolymer composition and from about 95% to about 5% by weight of said styrene polymer.

3. A polymer blend composition of claim 2 wherein said styrene maleic anhydride copolymer composition comprises about 50% by weight of the total weight of said component (i) and said styrene polymer is about 50% by weight of the total weight of said component (i).

4. A polymer blend composition of claim 1 wherein said styrene maleic anhydride copolymer composition of component (i) is selected from the group consisting of a styrene maleic anhydride copolymer and a rubber modified styrene maleic anhydride copolymer composition, and wherein said acrylic copolymer of component (ii) is selected from the group consisting of a styrene methyl methacrylic copolymer and a rubber modified styrene methyl methacrylic copolymer composition.

5. A polymer blend composition of claim 4 wherein said styrene maleic anhydride copolymer composition is a rubber modified styrene maleic anhydride copolymer composition and wherein said rubber modified styrene maleic anhydride copolymer composition of component (i) is comprised of:
from about 92.0% to about 99.9% by weight rubber modified styrene maleic anhydride copolymer; and
from about 0.1% to about 8.0% by weight of polybutene based on the weight of the rubber modified styrene maleic anhydride copolymer composition.

6. A polymer blend composition of claim 5 wherein the amount of said polybutene ranges from about 2% to about 6% by weight based on the weight of the rubber modified styrene maleic anhydride copolymer composition.

7. A polymer blend composition of claim 5 wherein the amount of said polybutene ranges from about 3% to about 5% by weight based on the weight of the rubber modified styrene maleic anhydride copolymer composition.

8. A polymer blend composition of claim 5 wherein said polybutene has a number average molecular weight ranging from about 900 to about 2500.

9. A polymer blend composition of claim 8 wherein said polybutene has a number average molecular weight ranging from about 900 to about 1300.

10. A polymer blend composition of claim 1 wherein said styrene polymer is selected from the group consisting of styrene, alpha methyl styrene, para methyl styrene, chlorostyrene, bromo-styrene, polystyrene, and rubber modified polystyrene.

11. A polymer blend composition of claim 4 wherein said rubber modified styrene maleic anhydride copolymer composition of component (i) is comprised of from about 2% to about 25% by weight of maleic anhydride and from about 4% to about 20% by weight of rubber based on the weight of said rubber modified styrene maleic anhydride copolymer composition.

12. A polymer blend composition of claim 11 wherein the amount of rubber in said rubber modified styrene maleic anhydride copolymer composition ranges from about 8% to about 15% by weight.

13. A polymer blend composition of claim 12 wherein the particle size of the rubber in said rubber modified styrene maleic anhydride copolymer composition ranges from about 0.1 micron to about 11 microns.

14. A polymer blend composition of claim 13 wherein the particle size of the rubber in said rubber modified styrene maleic anhydride copolymer composition is less than 6 microns.

15. A polymer blend composition of claim 14 wherein the particle size of the rubber in said rubber modified styrene maleic anhydride copolymer composition ranges between from about 0.1 micron to about 5 microns.

16. A polymer blend composition of claim 12 wherein said rubber in said rubber modified styrene maleic anhydride copolymer composition is polybutadiene.

17. A polymer blend composition of claim 16 wherein said rubber in said rubber modified styrene maleic anhydride copolymer composition is selected from the group consisting of high cis polybutadiene and medium cis polybutadiene.

18. An article produced from the polymer blend composition of claim 1.

19. An article of claim 18 produced by injection molding, sheet extrusion and thermoforming, foam extrusion and thermoforming processes.

20. A container suitable for use in packaging and heating food formed from the polymer blend composition of claim 1.

21. A multi-layer container suitable for us in microwave heating of food, said container comprising a substrate layer and a layer comprised of the polymer blend composition of claim 1.

22. The polymer blend composition of claim 1 having an IZOD impact ranging from about 3 to about 5 ft-pound-inch, a strain at break ranging from about 30% to about 50%, a flexural modulus ranging from about 300 ksi to about 350 ksi, and a total energy ranging from about 10 foot pound to about 15 foot pound.

23. A method for increasing a styrene maleic anhydride copolymer composition regrind including the steps of:
adding a styrene polymer to said regrind to form a blend (i) of said styrene polymer and said regrind; and
adding an acrylic copolymer composition (ii) to said blend (i) as a compatibilizer for said styrene maleic anhydride copolymer composition regrind and said styrene polymer.

24. A method of claim 23 wherein the weight percent of said styrene maleic anhydride copolymer composition regrind in said blend (i) ranges from about 5% to about 95% by weight and said styrene polymer ranges from about 95% to about 5% by weight based on the weight of said blend (i).

25. A method of claim 24 wherein the weight percent of said blend (i) ranges from about 70% to 95%, and the weight percent of said acrylic copolymer composition (ii) ranges from about 30 to about 5 percent.

26. A method of claim 23 wherein said styrene maleic anhydride copolymer composition is a rubber modified styrene maleic anhydride copolymer and wherein said acrylic copolymer is a rubber modified styrene methyl methacrylate copolymer.
